(19) United States
(12) Patent Application Publication
(10) Pub. No.: US 2026/0099303 A1
(43) Pub. Date: Apr. 9, 2026

(54) CODE GENERATION METHOD AND APPARATUS, STORAGE MEDIUM AND ELECTRONIC DEVICE

(71) Applicant: DOUYIN VISION CO., LTD., Beijing (CN)

(72) Inventors: Luping Liu, Beijing (CN); Qinyun Wu, Beijing (CN); Ping Yang, Beijing (CN); Landong Lin, Beijing (CN); Jie Liu, Beijing (CN); Huan Song, Beijing (CN)

(21) Appl. No.: 19/114,774

(22) PCT Filed: Feb. 7, 2024
(86) PCT No.: PCT/CN2024/076711

§ 371 Date: Mar. 24, 2025

(30) Foreign Application Priority Data
Feb. 23, 2023 (CN) 202310190548.6

(51) Int. Cl. G06F 8/35; G06N 3/04; G06N 3/08

(52) U.S. Cl. CPC G06F 8/35; G06N 3/04; G06N 3/08

(57) ABSTRACT

The present disclosure relates to a code generation method and apparatus, a storage medium, and an electronic device, to improve the accuracy of automatically generated code. The method includes: acquiring target text, where the target text includes program code text to be supplemented or natural language text for describing a code function; and inputting the target text into a code generation model to obtain a target program code generated based on the target text, where the code generation model is obtained by training a code understanding task and a code generation task, the code understanding task is used for the code generation model to learn a syntax feature and a semantic feature of a sample program code, and the code generation task is used for the code generation model to learn a process of generating a new program code based on the sample program code.

### CROSS-REFERENCE TO RELATED APPLICATION(S)

The present application claims priority to Chinese Patent Application No. 202310190548.6, filed on Feb. 23, 2023, the disclosure of which is hereby incorporated by reference in its entirety.

### FIELD

The present disclosure relates to the field of computer technologies and, in particular, to a code generation method and apparatus, a storage medium, and an electronic device.

### BACKGROUND

Automatic program code generation is an important technologies for software intelligence, which can assist software developers in completing the development of some general-purpose codes, thereby effectively improving the research and development efficiency and saving the research and development costs. In addition, with the continuous development of natural language processing technologies, pre-trained language models are widely used in program code generation. However, the related art mainly performs code generation based on a conditional probability language model, that is, predicting the probability of the occurrence of the next program symbol based on existing preceding text information, and only the statistical distribution of the program symbols can be learned.

### SUMMARY

This Summary is provided to introduce concepts in a simplified form that are described in detail in the following Detailed Description. This Summary is not intended to identify key features or essential features of the claimed technical solutions, nor is it intended to be used to limit the scope of the claimed technical solutions.

In a first aspect, the present disclosure provides a code generation method, including:
acquiring target text, the target text including program code text to be supplemented or natural language text for describing a code function; and
inputting the target text into a code generation model to obtain a target program code generated based on the target text, where the code generation model is obtained by training with a code understanding task and a code generation task, and the code understanding task is used for the code generation model to learn a syntax feature and a semantic feature of a sample program code, and the code generation task is used for the code generation model to learn a process of generating a new program code based on the sample program code.

In a second aspect, the present disclosure provides a code generation apparatus, including:
an acquiring module, configured to acquire target text, the target text being program code text to be supplemented or natural language text for describing a code function; and
a generation module, configured to input the target text into a code generation model to obtain a target program code generated based on the target text, where the code generation model is obtained by training with a code understanding task and a code generation task, and the code understanding task is used for the code generation model to learn a syntax feature and a semantic feature of a sample program code, and the code generation task is used for the code generation model to learn a process of generating a new program code based on the sample program code.

In a third aspect, the present disclosure provides a non-transitory computer readable medium, on which a computer program is stored, where the program, when executed by a processing apparatus, implements the steps of the method according to the first aspect.

In a fourth aspect, the present disclosure provides an electronic device, including:
a storage apparatus, on which a computer program is stored; and
a processing apparatus, configured to execute the computer program in the storage apparatus to implement the steps of the method according to the first aspect.

According to the above technical solutions, the code generation model can be obtained by training the code understanding task and the code generation task. The code understanding task is used for the code generation model to learn the syntax and semantic knowledge of the sample program code, and the code generation task is used for the code generation model to learn the process of generating the new program code based on the sample program code. Thus, the trained code generation model can generate the target program code according to the syntax and semantics of the target text, thereby improving the accuracy of automatic code generation.

Other features and advantages of the present disclosure will be described in detail in the following detailed description.

### BRIEF DESCRIPTION OF THE DRAWINGS

The above and other features, advantages, and aspects of embodiments of the present disclosure become more apparent with reference to the following Detailed Description when taken in conjunction with the drawings. Throughout the drawings, the same or similar reference numerals refer to the same or similar elements. It should be understood that the drawings are schematic and that parts and elements are not necessarily drawn to scale. In the drawings:

FIG. 1 is a flowchart of a code generation method according to an exemplary embodiment of the present disclosure;

FIG. 2 is a schematic diagram of a process of a code generation method according to an exemplary embodiment of the present disclosure;

FIG. 3 is a schematic diagram of a code generation model in a code generation method according to an exemplary embodiment of the present disclosure;

FIG. 4 is a schematic diagram of a process of a code generation method according to another exemplary embodiment of the present disclosure;

FIG. 5 is a schematic diagram of a mask matrix in a code generation method according to an exemplary embodiment of the present disclosure;

FIG. 6 is a schematic diagram of a process of a code generation method according to another exemplary embodiment of the present disclosure;

FIG. 7 is a block diagram of a code generation apparatus according to an exemplary embodiment of
the present disclosure; and

FIG. 8 is a block diagram of an electronic device according to an exemplary embodiment of the present disclosure.

### DETAILED DESCRIPTION OF EMBODIMENTS

Hereinafter, embodiments of the present disclosure will be described in more detail with reference to the drawings. Although some embodiments of the present disclosure are shown in the drawings, it should be understood that the present disclosure can be implemented in various forms and should not be construed as being limited to the embodiments set forth herein, and on the contrary, these embodiments are provided for a more thorough and complete understanding of the present disclosure. It should be understood that the drawings and embodiments of the present disclosure are only for exemplary purposes, and are not intended to limit the scope of protection of the present disclosure.

It should be understood that various steps described in the method implementations of the present disclosure may be performed in different orders and/or in parallel. In addition, the method implementations may include additional steps and/or omit the execution of the illustrated steps. The scope of the present disclosure is not limited in this aspect.

The term “include/comprise” and its variants used herein are open-ended inclusions, that is, “include/comprise but not limited to”. The term “based on” is “at least partially based on”. The term “one embodiment” represents “at least one embodiment”, the term “another embodiment” represents “at least one additional embodiment”, and the term “some embodiments” represents “at least some embodiments”. Relevant definitions of other terms will be given in the following description.

It should be noted that concepts such as “first” and “second” mentioned in the present disclosure are only used to distinguish different apparatuses, modules, or units, and are not used to limit the order of functions performed by these apparatuses, modules, or units or the interdependence relationship. In addition, it should be noted that the modifiers of “one” and “a plurality of” mentioned in the present disclosure are schematic rather than restrictive, and those skilled in the art should understand that unless the context clearly indicates otherwise, it should be understood as “one or more”.

The names of messages or information exchanged between a plurality of apparatuses in the implementations of the present disclosure are only used for illustrative purposes, and are not intended to limit the scope of these messages or information.

It should be understood that before the technical solutions disclosed in the embodiments of the present disclosure are used, the user should be informed of and give consent to the type, use scope, use scenario, etc, of the personal information involved in the present disclosure in an appropriate manner in accordance with relevant laws and regulations.

For example, in response to receiving an active request from a user, prompt information is sent to the user to explicitly prompt the user that the operation requested to be performed will require the acquisition and use of the user's personal information. Thus, the user can independently choose whether to provide personal information to software or hardware such as an electronic device, an application, a server, or a storage medium that performs the operation of the technical solution of the present disclosure according to the prompt information.

As an optional but non-limiting implementation, the manner of sending the prompt information to the user in response to receiving the active request from the user may be, for example, a pop-up window, and the prompt information may be presented in text in the pop-up window. In addition, the pop-up window may also carry a selection control for the user to select “agree” or “disagree” to provide personal information to the electronic device.

It should be understood that the above process of notifying and obtaining the user's authorization is only illustrative and does not constitute a limitation on the implementations of the present disclosure, and other manners that satisfy relevant laws and regulations may also be applied to the implementations of the present disclosure.

At the same time, it should be understood that the data involved in the technical solution (including but not limited to the data itself, the acquisition or use of the data) should comply with the requirements of corresponding laws, regulations, and related provisions.

As mentioned in the Background section, with the continuous development of natural language processing technologies, pre-trained language models are widely used in program code generation. However, such methods regard program code as a symbol sequence similar to natural language texts, and adopt a conditional probability autoregressive generation method to train code generation, which cannot effectively learn the semantics of the program code, but can only learn the statistical distribution of the program symbols, and the structural information of the program code cannot be effectively captured.

Based on this, the present disclosure provides a code generation method, and a multi-task learning method of program code understanding and program code generation can be fused in a training process of a code generation model. That is, in order to enable the model to effectively learn the syntax and semantic knowledge of the program code, two major types of training tasks are set in the present disclosure in total on a training target: a code understanding task and a code generation task. In the code understanding task, the model can learn basic syntax knowledge and semantic knowledge of the program code, so that in a model application stage, the model can generate the program code according to the syntax and semantics of the input text, thereby improving the accuracy of the generated code.

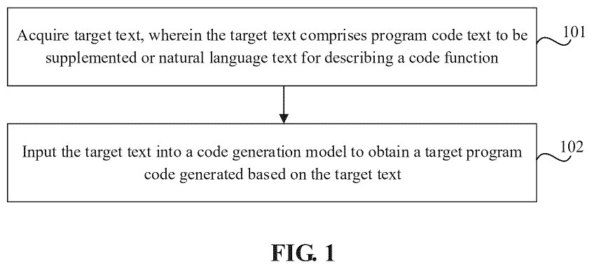

FIG. 1 is a flowchart of a code generation method according to an exemplary embodiment of the present disclosure. With reference to FIG. 1, the code generation method may include the following steps.

Step 101: acquiring target text, where the target text includes program code text to be supplemented or natural language text for describing a code function.

Step 102: inputting the target text into a code generation model to obtain a target program code generated based on the target text, wherein the code generation model is obtained by training with a code understanding task and a code generation task, the code understanding task is used for the code generation model to learn a syntax feature and a semantic feature of a sample program code, and the code generation task is used for the code generation model to learn a process of generating a new program code based on the sample program code.

It should be understood that the target text input into the code generation model in the present disclosure may include a program code to be supplemented or natural language text for describing a code function. The program code to be supplemented may be an incompletely written program code, and after the program code to be supplemented is input into the code generation model, the code generation model can output a complete program code according to the program code to be supplemented. The natural language text for describing a code function may be, for example, natural language text determined according to an actual service function, and after the natural language text is input into the code generation model, the code generation model can output a program code that can implement the service function. Therefore, automatic code generation can be realized, and the efficiency of code generation can be improved. In addition, in a training stage of the code generation model, code understanding and code generation pre-training tasks are introduced at the same time, so that in the application stage, the code generation model can effectively capture the syntax and semantic knowledge in the target text to enhance the performance of code generation, thereby improving the accuracy of the generated program code.

The training process of the code generation model is described below first.

First, the sample program code may be acquired, then tokenization is performed on the sample program code and the sample program code is split into a token sequence with a fixed length, and finally the code generation model is trained based on the token sequence. The fixed length may be 1.024 tokens.

In some embodiments, the sample program code may be obtained by: acquiring a code dataset comprising a plurality of code files; performing at least one of the following preprocessing steps for each of the code files to obtain a training dataset; when the proportion of the number of characters to the total number of symbols in a code file is greater than or equal to a preset character proportion, adding the code file to the training dataset; when the average number of characters per line of code in a code file is less than or equal to a first preset threshold, adding the code file to the training dataset; and when the number of characters of comment information in a code file is less than or equal to a second preset threshold, adding the code file to the training dataset; and determining the program code corresponding to each of the code files in the training dataset as the sample program code.

The preset character proportion, the first preset threshold, and the second preset threshold may be set according to actual conditions, which are not limited in the embodiments of the present disclosure. For example, the preset character proportion may be set to 40%, the first preset threshold may be set to 100, and the second preset threshold may be set to 500.

It should be understood that the directly acquired code dataset usually contains a large amount of duplicate code data and low-quality code data, and in order to avoid these duplicate code data and low-quality data from affecting the learning process of the model, the acquired code dataset may be preprocessed first.

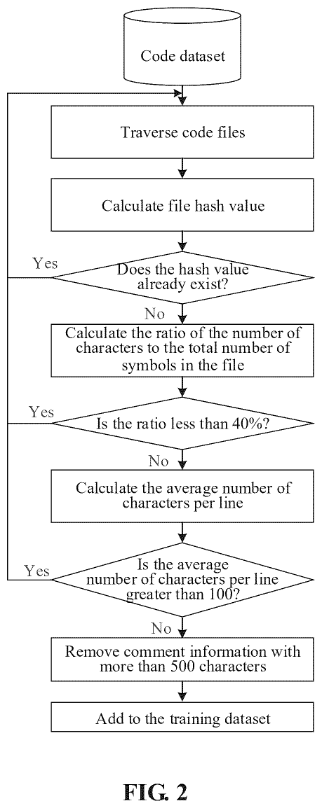

For example, with reference to FIG. 2, first, code files are traversed from the code dataset in sequence and the MD5 (Message-Digest Algorithm) hash value of the files is calculated. The hash value is stored after the first calculation, and after the hash value is calculated for the second time, the hash value is compared with the stored hash value. If the hash value exists, it indicates that the file is a duplicate file and can be discarded; if the hash value does not exist, the hash value of this time is stored, and so on, and duplicate removal processing is performed on the code files in the code dataset. After that the ratio of the number of characters (the number of characters composed of at least one of 26 English letters) in the file to the total number of symbols (the number of letters, spaces and other special characters, where one space is counted as one character) in the code file and the average number of characters per line in the code file may be calculated. If the proportion of the number of characters to the total number of symbols in the code file is less than 40% or the average number of characters per line in the code file exceeds 100, it can be considered that this is a code file containing a lot of noise, so that the code file is not added to the training dataset, and the calculation of the next code file is continued. On the contrary, if the proportion of the number of characters to the total number of symbols in the code file is greater than or equal to 40% or the average number of characters per line in the code file does not exceed 100, the code file may be added to the training dataset. Next, in the preprocessing stage, comment information with more than 500 characters in the code file may be removed to improve the quality of the training data. Finally, the program code corresponding to each code file in the training dataset is determined as the sample program code.

Through the above manner, duplicate and low-quality code data can be filtered based on original code data, and a high-quality training dataset can be established, thereby reducing the influence of duplicate and low-quality code data on model training, improving the training effect, and further improving the accuracy of the result of the trained code generation model.

In some embodiments, the code generation model includes a code understanding layer, a code generation layer, and a shared representation layer, and the result output by the shared representation layer can be used to input the code understanding layer or the code generation layer. Correspondingly, the training steps of the code generation model include: when the code understanding task is executed, performing masking processing on the sample program code to obtain a mask sequence, inputting the mask sequence into the code generation model to obtain a first prediction code by the shared representation layer and the code understanding layer, and adjusting parameters of the code understanding layer and the shared representation layer based on the first prediction code; and when the code generation task is executed, inputting the sample program code into the code generation model to obtain a second prediction code by the shared representation layer and the code generation layer, and adjusting parameters of the code generation layer and the shared representation layer based on a result output by the code generation model.

That is, when the code understanding task is executed, the training may be performed by means of a masked language model. When the code generation task is executed, the training may be performed by means of a conditional language model.

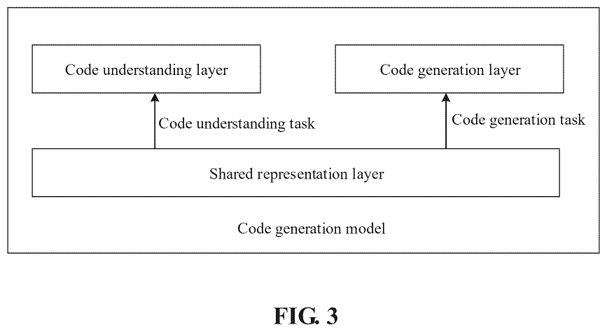

For example, with reference to FIG. 3, the code generation model includes the shared representation layer, the code understanding layer, and the code generation layer, and in the training stage, parameters of the shared representation layer and the code understanding layer can be adjusted through the code understanding task, and then parameters of the shared representation layer and the code generation layer can be adjusted through the code generation task. Thus, in the model application stage, the syntax and semantic knowledge of the target text can be identified, thereby outputting a more accurate target program code through the syntax and semantic knowledge.

The training process of the code understanding task is described below.

In some embodiments, the performing masking processing on the sample program code to obtain the mask sequence includes: performing tokenization on the sample program code to obtain a token sequence; randomly selecting a first preset proportion of first target tokens in the token sequence, and replacing the first target tokens with a first preset mask symbol to obtain the mask sequence; and/or randomly selecting a second preset proportion of second target tokens in the token sequence, and randomly selecting one target remaining token from remaining tokens for each second target token, and replacing the second target token with the target remaining token to obtain the mask sequence.

The remaining tokens are tokens in the token sequence except the second target tokens. The first preset proportion, the second preset proportion, and the first preset mask symbol may be set according to actual conditions, which are not limited in the embodiments of the present disclosure. For example, the first preset proportion is set to 12%, the second preset proportion is set to 1.5%, and the first preset mask symbol is set to [MASK]. In addition, the tokens with the first preset proportion and the second preset proportion may be directly selected, or a certain proportion of tokens may be selected first, and then a certain proportion of tokens may be selected from the selected tokens. For example, after the token sequence corresponding to the training sample is determined. 15% of tokens in the token sequence are randomly selected in units of tokens, then 80% of the selected tokens (that is, the first target tokens) are replaced with the [MASK] symbol, and 10% of the selected tokens (that is, the second target tokens) are randomly replaced with other tokens to obtain the mask sequence. Thus, by training the code generation model with the mask sequence, the model can be made to learn to recover the masked token information from the mask sequence, so that the model can learn the basic syntax knowledge of the program code.

In some embodiments, the performing masking processing on the sample program code to obtain the mask sequence includes: performing tokenization on the sample program code to obtain a token sequence; determining a function token for characterizing a function name in the token sequence, randomly selecting a third preset proportion of target function tokens in the function tokens, and replacing the target function tokens with a second preset mask symbol to obtain the mask sequence; and/or determining an interface token for characterizing an interface name in the token sequence, randomly selecting a fourth preset proportion of target interface tokens in the interface tokens, and replacing the target interface tokens with a third preset mask symbol to obtain the mask sequence.

The third preset proportion, the fourth preset proportion, the second preset mask symbol, and the third preset mask symbol may be set according to actual conditions, which are not limited in the embodiments of the present disclosure. For example, the third preset proportion and the fourth preset proportion are both set to 20%, and the third preset mask symbol and the fourth preset mask symbol are both set to [MASK], that is, 20% of tokens of the function name in the sample program code may be replaced with the [MASK] symbol, and/or 20% of tokens of the interface (API. Application Programming Interface) name in the sample program code may be replaced with the [MASK] symbol to obtain the mask sequence. After that, by training the code generation model with the mask sequence, the model can be made to learn to recover the masked function name and API name, so that the model can learn semantic knowledge such as the corresponding relationship between the function name and the function body and the application program interface.

In practical applications, the masking processing may be performed in any of the above manners, or the masking processing may be performed in conjunction with the above two manners, which is not limited in the embodiments of the present disclosure.

After the mask sequence is obtained, the mask sequence may be input into the code generation model to obtain the first prediction code by the shared representation layer and the code understanding layer. In some embodiments, a feature vector sequence corresponding to the mask sequence may be determined first. Then, for each feature vector in the feature vector sequence, the shared representation layer performs calculation according to all feature vectors located before and after the feature vector in the feature vector sequence and an attention mechanism to obtain an intermediate feature vector, and then for each intermediate feature vector, the code understanding layer performs attention calculation according to intermediate feature vectors except the intermediate feature vector and the attention mechanism to obtain a target feature vector. Finally, the first prediction program code is obtained according to the target feature vector.

The calculation performed by the shared representation layer according to all feature vectors located before and after the feature vector in the feature vector sequence and the attention mechanism is equivalent to the bidirectional attention calculation performed by the shared representation layer. The attention calculation performed by the code understanding layer according to the intermediate feature vectors except the intermediate feature vector and the attention mechanism is equivalent to the bidirectional attention calculation performed by the code understanding layer. Thus, when the code understanding task is executed, the shared representation layer and the code understanding layer both perform the bidirectional attention calculation, so that code understanding can be performed in conjunction with preceding text and following text, thereby more accurately identifying the syntax and semantic knowledge of the input text.

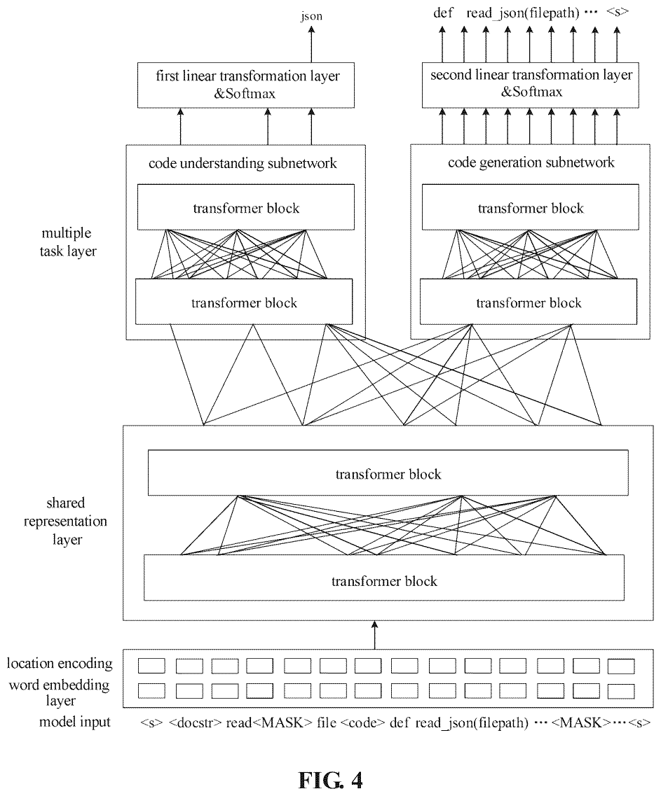

For example, with reference to FIG. 4, the execution process of each layer of the model in the training stage is described by taking the code generation model as a Transformer as an example. First, the code fragments obtained after tokenization of the sample program code pass through a token embedding layer and a position encoding layer to obtain a token vector representation of each token. The token embedding layer obtains a corresponding token embedding vector from a token embedding matrix by looking up a table. The token vector matrix is a matrix with a size of 42.000×1.024, where 42.000 is the size of a vocabulary, and 1.024 is the dimension of the token vector. The position encoding layer calculates a position encoding vector of each token by means of cosine-based position encoding. Finally, the token embedding vector corresponding to each token and the position encoding vector are added to obtain the token vector of the token, as shown in formula (1):

$${H}_{embeddding}^{i} = WordEmbedding ( i ) + PositionEmbedding ( i ) where {H}_{embeddding}^{i} \qquad ( 1 )$$

represents the token vector corresponding to the i-th token. WordEmbedding(i) represents the token embedding vector corresponding to the i-th token, and PositionEmbedding(i) represents the position encoding vector corresponding to the i-th token.

The sequence after the token embedding layer is input into the shared representation layer for encoding. The shared representation layer may be formed by stacking a plurality of transformer basic blocks (transformer block), and each basic block is composed of a multi-head attention sublayer and a forward feedback sublayer (not shown in FIG. 4). The multi-head attention sublayer is used to calculate the correlation between each token in the input sequence. In practical applications, the number of attention heads may be set to 16, that is. 16 attention heads may be used, which is not limited in the embodiments of the present disclosure. In each attention head, the encoding representation hᵢ of the i-th token may be obtained through calculation by a self-attention mechanism, as shown in formula (2):

$${h}_{i} = softmax ( \frac{{QK}^{T}}{\sqrt{{d}_{k}}} ) V \qquad ( 2 )$$

where Q represents a query vector obtained by linearly transforming the token vector Hⁱ embedding of the i-th token. K represents a key vector obtained by linearly transforming the token vector Hⁱ embedding of the i-th token. V represents a value vector obtained by linearly transforming the token vector Hⁱ embedding of the i-th token. K^{T} represents the transpose of K, and dₖ represents the dimension of K.

After the encoding representation hᵢ output by the single attention head is obtained, the outputs of the plurality of attention heads are spliced and then pass through a fully connected layer to obtain the encoding representation mᵢ of the i-th token, as shown in formula (3):

$${m}_{i} = concat ( {h}_{1}^{′} , ¨ , {h}_{h}^{′} ) {W}^{o} \qquad ( 3 )$$

where concat represents vector concatenating, h′₁ represents the encoding representation output by the first attention head, h′ₙ represents the encoding representation output by the hth attention head, and W^{o} represents a parameter of the multi-head attention sublayer.

Further, in order to prevent the gradient from disappearing, the output of the multi-head attention sublayer may pass through a residual connection and a normalization layer, and then the output hᵢ^{m} is obtained, as shown in formula (4):

$${h}_{i}^{m} = LayerNorm ( {m}_{i} + {H}_{embeddding}^{i} ) \qquad ( 4 )$$

where LayerNorm represents a normalization function.

After that, the forward feedback sublayer further processes the vector output by the multi-head attention sublayer. The forward feedback sublayer is composed of two full connections and one ReLU activation unit, and the calculation process is shown in formula (5):

$${h}_{i}^{″} = max ( 0 , {h}_{i}^{m} {W}_{1} + {b}_{1} ) {W}_{2} + {b}_{2} \qquad ( 5 )$$

where max represents a maximum function, h″ᵢ represents the output of the forward feedback sublayer, W₁ and W₂ represent parameters of the forward feedback sublayer, and b₁ and b₂ are corresponding biases. It should be understood that for the specific calculation process, reference may be made to the calculation process of a transformer model in the related art, which will not be repeated here.

Similarly, the output of the forward feedback sublayer also passes through the residual connection and the normalization layer, and then the output

$${h}_{i}^{s}$$

of the shared representation layer is obtained, as shown in formula (6):

$${h}_{i}^{s} = LayerNorm ( {h}_{i}^{″} + {h}_{i}^{m} ) \qquad ( 6 )$$

Thus, the shared representation layer may perform the bidirectional attention calculation according to all feature vectors located before and after the feature vector in the feature vector sequence to obtain the intermediate feature vector, that is,

$${h}_{i}^{s} .$$

After that, for each intermediate feature vector, the code understanding layer performs the bidirectional attention calculation according to the intermediate feature vectors except the intermediate feature vector to obtain the target feature vector. For example, following the above example, the output hᵢ^{s} of the shared representation layer is obtained through the bidirectional attention calculation of the code understanding sub-network, and then the corresponding target feature vector is obtained through the residual layer and the forward feedback layer in turn. The calculation process is similar to the calculation process of the shared representation layer, and reference may be made to the foregoing description, which will not be repeated here.

Finally, the first prediction program code is obtained according to the target feature vector, and the parameters of the code understanding layer and the shared representation layer are adjusted based on the first prediction program code.

For example, following the above example, the mask sequence obtained after the masking processing is input into the code generation model, and then the feature representation h^{s} of each token is obtained. Subsequently,

$${h}_{m}^{s}$$

corresponding to the masked token is obtained through the first linear transformation layer to obtain the probability

$${pred}_{i}^{s}$$

that the token belongs to different tokens in the vocabulary, and then the probability is calculated by a softmax function to obtain the normalized probability pᵤ, as shown in formula (7) and formula (8):

$${pred}_{i}^{s} = {W}_{u} {h}_{m}^{s} + {b}_{u} \qquad ( 7 )$$

$${p}_{u} ( m = {m}_{i} \vert θ , {m}_{i} ∈ [ 1 , 2 , , N ] ) = softmax ( {pred}_{i}^{s} ) \qquad ( 8 )$$

where Wᵤ represents a parameter of the first linear transformation layer, bᵤ represents a corresponding bias, m represents a masked token, mᵢ represents a label of a correct token corresponding to the masked token. θ represents a parameter of the code generation model, and N represents the total number of tokens in the vocabulary.

Then, the loss function of the code understanding task is calculated, as shown in formula (9):

$${L}_{1} = - {\sum }_{i = 1}^{M} log {p}_{u} ( m = {m}_{i} \vert θ , {m}_{i} ∈ [ 1 , 2 , … , N ] \qquad ( 9 )$$

where L₁ represents the loss function value calculated in the code understanding task, and M represents the number of masked tokens.

Finally, the parameters of the code understanding layer and the shared representation layer may be adjusted according to the loss function value L₁, and this process is similar to that in the related art, which will not be repeated here.

Thus, when the code understanding task is executed, the shared representation layer and the code understanding layer both perform the bidirectional attention calculation, so that code understanding can be performed in conjunction with the preceding text information and the following text information, thereby more accurately identifying the syntax and semantic knowledge of the input text.

The training process of the code generation task is described below.

When the code generation task is executed, the sample program code may be input into the code generation model to obtain the second prediction code by the shared representation layer and the code generation layer, and the parameters of the code generation layer and the shared representation layer may be adjusted based on the result output by the code generation model.

In some embodiments, the inputting the sample program code into the code generation model to obtain the second prediction code by the shared representation layer and the code generation layer includes: determining a feature vector sequence corresponding to the sample program code, where the feature vector sequence includes N feature vectors, and N is a positive integer; calculating, for an i-th feature vector in the feature vector sequence, by the shared representation layer, according to all feature vectors located before and after the i-th feature vector in the feature vector sequence and an attention mechanism, to obtain an i-th intermediate feature vector, where i is a positive integer; calculating, for the i-th intermediate feature vector, by the code generation layer, according to preceding feature vectors and the attention mechanism, to obtain a target feature vector, where the preceding feature vectors are all intermediate feature vectors obtained before the i-th intermediate feature vector; and obtaining a second prediction program code according to the target feature vector.

The calculation performed by the shared representation layer according to all feature vectors located before and after the i-th feature vector in the feature vector sequence and the attention mechanism is equivalent to the bidirectional attention calculation performed by the shared representation layer. The calculation performed by the code generation layer according to the preceding feature vectors and the attention mechanism is equivalent to the unidirectional attention calculation performed by the code generation layer. That is, when the code generation task is executed, the shared representation layer performs the bidirectional attention calculation, and the code understanding layer performs the unidirectional attention calculation, so that the next token can be predicted according to the preceding text information of the token, thereby implementing code generation. In addition, since the shared representation layer can adjust the parameters through the code understanding task, the shared representation layer can obtain the corresponding features in conjunction with the syntax and semantic knowledge of the preceding text information and input them into the code generation layer for processing, thereby implementing code generation in conjunction with the syntax and semantic knowledge of the input text, and improving the accuracy of code generation.

For example, with reference to FIG. 3, the multi-task layer includes two sub-networks: code understanding and code generation, and the two sub-networks are composed of a plurality of transformer basic blocks. The difference is that the code understanding sub-network adopts the same bidirectional attention calculation method as the shared representation layer, that is, when calculating the dependency relationship of a certain token, the dependency relationship between the token and the preceding and following tokens will be calculated, while the code generation sub-network adopts a unidirectional attention calculation method, that is, when calculating the dependency relationship of a certain token, only the dependency relationship between the token and the preceding token will be calculated. For example, the code generation sub-network adopts a mask-based attention mechanism to calculate the feature representation of the token, as shown in formula (10):

$${h}_{i}^{m a s k} = softmax ( {M}^{′} \frac{{{Q}^{s} ( {K}^{s} )}^{T}}{\sqrt{{d}_{k}^{′}}} ) {V}^{s} \qquad ( 10 )$$

where Q^{s} represents a query vector obtained by linearly transforming

$${h}_{i}^{s} ,$$

K^{s} represents a key vector obtained by linearly transforming

$${h}_{i}^{s} ,$$

V^{s} represents a value vector obtained by linear transforming

$${h}_{i}^{s} ,$$

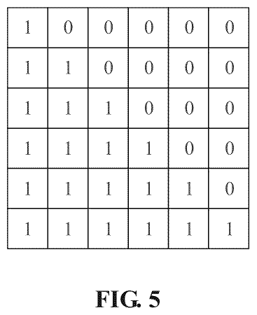

K^{T} represents the transpose of K, d′ₖ represents the dimension of K^{s}. M′ represents a mask matrix with a size of n×n, n represents the length of the input sequence, and the values of all elements on the diagonal and on the left side of the matrix are 1, while the values of all elements on the right side of the diagonal are 0. For example. FIG. 5 is an example of a mask matrix with an input sequence length of 6.

It should be understood that for other calculation processes of the code generation task sub-network, reference may be made to the calculation process of the native transformer in the related art, and details are not described herein again.

As mentioned above, in the code generation sub-network, after the mask matrix is introduced, the feature output

$${h}_{i}^{g}$$

of the ith token is obtained by weighted summation of its preceding feature vectors, and thus it represents the feature representation of the preceding sequence. Thus, the feature output

$${h}_{i}^{g}$$

of each token calculated in the code generation sub-network may pass through the second linear transformation layer to obtain the probability

$$p r e {d}_{i}^{g}$$

that each token belongs to different tokens in the vocabulary, and the normalized probability P_{g} that the token belongs to different tokens in the vocabulary is obtained through calculation by the softmax function, as shown in formula (11) and formula (12):

$${pred}_{i}^{g} = {W}_{g} {h}_{i}^{g} + {b}_{g} \qquad ( 11 )$$

$${P}_{g} ( {m}^{′} = {m}_{i}^{′} \vert θ , {m}_{i} ∈ [ 1 , 2 , … , N ] = softmax ( {pred}_{i}^{g} ) \qquad ( 12 )$$

where W_{g} represents a parameter of the second linear transformation layer, b_{g} represents a corresponding bias, m′ represents a prediction token to be generated next, and m′ᵢ represents label information of a correct token corresponding to the prediction token.

Then, the loss function of the code generation task is calculated, as shown in formula (13):

$${L}_{2} = - {\sum }_{i = 1}^{{M}^{″}} log {P}_{g} ( {m}^{′} = {m}_{i}^{′} \vert θ , {m}_{i} ∈ [ 1 , 2 , … , N ] \qquad ( 13 )$$

where L₂ represents the loss function value calculated in the code generation task, and M″ represents the number of generated prediction tokens.

Finally, the parameters of the code generation layer and the shared representation layer may be adjusted according to the loss function value L₂, and this process is similar to that in the related art, which will not be repeated here.

Through the above manner, in the training process of the code generation model, the code understanding task and the code generation task may be executed iteratively. For example, in the first round of iteration, the code understanding task is executed first to train the model through the loss function value L₁, and during this process, only the parameters of the shared representation layer and the code understanding layer of the model are updated. Subsequently, in the second round of iteration, the code generation task is executed to train the model through the loss function value L₂, and during this process, only the parameters of the shared representation layer and the code generation layer of the model are updated. This cycle is repeated until the condition for ending the model training is satisfied, for example, the loss function value L₁ and the loss function value L₂ are both less than a preset threshold. In addition, in the entire training process, the corresponding parameters of the model may be updated by means of gradient descent, which is not limited in the embodiments of the present disclosure.

The application process of the code generation model is described below.

After the code generation model is obtained through training in the above manner, tokenization may be performed on the natural language sentence or the program code fragment to be supplemented to obtain a to-be-processed token sequence, and then the to-be-processed token sequence is input into the trained code generation model to obtain a new target program code.

It should be understood that in the application stage, the code generation model only uses the shared representation layer and the code generation layer to predict the probability of each token in the target program code, and the steps may include the following steps. 1. Tokenization is performed on the natural language sentence or the program code fragment to be supplemented to obtain the to-be-processed token sequence. 2. The to-be-processed token sequence is input into the code generation model, and the feature representation

$${h}_{o}^{g}$$

of the next prediction token is obtained after encoding. 3. The feature representation

$${h}_{o}^{g}$$

of the next prediction token is sent to the linear decoding layer, and then the probability distribution

$${P}_{g}^{′}$$

of the prediction token in the vocabulary is obtained after calculation by the softmax function. For the specific calculation process, reference may be made to formula (11) and formula (12). 4. After the probability distribution

$${P}_{g}^{′}$$

is obtained, the target prediction token to be output is selected according to the probability. 5. The target prediction token is spliced to the to-be-processed token sequence and then input into the model, and step 3 and step 4 are repeatedly executed to obtain a new prediction token, and the generation is stopped when the preset maximum sequence length is reached directly or the output prediction token is an end symbol.

In some embodiments, in step 4, the tokenization with the highest probability may be selected as the target prediction token for output. Alternatively, in some embodiments, in order to increase the diversity of the output target prediction tokens, the prediction token may be obtained by means of a nucleus sampling decoding algorithm.

For example, the code generation model may be used to obtain the target program code generated based on the target text by: determining a prediction token based on the target text, and using the prediction token as an initial target token to cyclically perform the following process: concatenating the target token into a token sequence corresponding to the target text to obtain a target token sequence, determining a plurality of candidate prediction tokens and a probability of each candidate prediction token in a preset vocabulary based on the target token sequence, and randomly selecting one token from a candidate set corresponding to the candidate prediction tokens as a new target token, until the length of the target token sequence reaches a preset length or the target token is a preset end symbol. The sum of the probabilities of the candidate prediction tokens in the candidate set is greater than a preset probability.

For example, after the probability distribution P_{g}′ is obtained, first, a candidate set Vₚ is selected from the probability distribution P_{g}′ such that the sum of the probabilities of all candidate prediction tokens in the candidate set is greater than the preset probability p, and then the probabilities of all candidate prediction tokens in the candidate set Vₚ are normalized, and one token is randomly sampled therefrom as the target token. The calculation process is shown in formula (14):

$${\sum }_{x ∈ {V}_{p}} {P}_{g}^{′} ( x \vert {x}_{1 : i - 1} ) \geq p \qquad ( 14 )$$

where x represents the prediction token, and the preset probability p may be set according to actual conditions, for example, it may be set to 0.95, which is not limited in the embodiments of the present disclosure.

After a target token is obtained through prediction, the target token is spliced with the token sequence input into the code generation model to obtain the target token sequence, and then the target token sequence is input into the code generation model. Step (3) and step (4) are repeatedly executed to predict and output a new target token, until the length of the target token sequence reaches the preset length or the output target token is the preset end symbol. The preset length and the preset end symbol may be set according to actual conditions, which are not limited in the embodiments of the present disclosure.

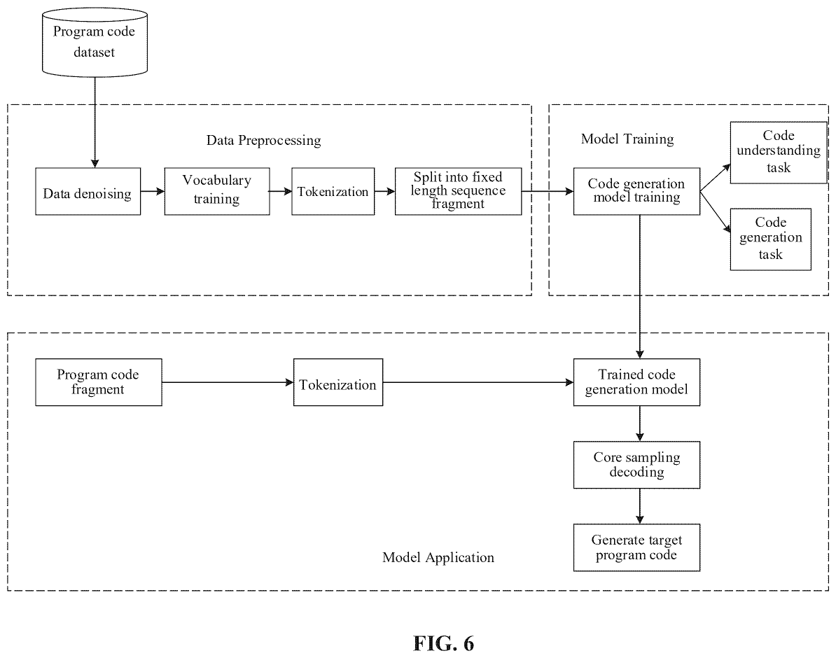

For example, with reference to FIG. 6, the code generation method provided in the present disclosure mainly includes three processes: data preprocessing, model training, and model application. It should be understood that for the specific processing manners of the three processes, reference may be made to the foregoing description, and a brief description is given below. First, in the data preprocessing process, the program code dataset may be acquired, and then data de-noising is performed on the program code dataset, and vocabulary training is performed by means of a BPE (Byte Pair Encoding) tokenization algorithm to obtain a vocabulary for subsequent tokenization. After that, tokenization is performed on the de-noised data by using the trained vocabulary and the de-noised data is split into a sequence fragment with a fixed length, and the sequence fragment with the fixed length is input into the code generation model for training. In the model training process, the code generation model is trained based on the code understanding task and the code generation task. In the model application process, for the program code fragment to be supplemented, tokenization is performed first to obtain the to-be-processed token sequence, and then the token sequence to be processed is input into the trained code generation model. After that the final target program code is obtained by means of the nucleus sampling decoding algorithm.

Thus, the code generation model may be trained based on the multi-task learning method of code understanding and code generation. In the code understanding task, on the one hand, a masked language model may be used to allow the model to learn to recover token information from a masked text, and the masked tokens are randomly selected, so that the model can learn basic syntax knowledge of the program code. On the other hand, the code understanding task may allow the model to learn to recover the masked function name and API name, thereby learning semantic knowledge such as the corresponding relationship between the function name and the function body. In the code generation task, an autoregressive conditional language model may be used for training, that is, predicting the next most likely code text symbol through preceding text information. Thus, the trained code generation model may output a more accurate target program code based on the program code text to be supplemented or the natural language text for describing the code function.

Based on the same concept, the present disclosure further provides a code generation apparatus, which may be part or all of an electronic device in a form of software, hardware or a combination of both. With reference to FIG. 7, the code generation apparatus 700 includes:
an acquiring module 701, configured to acquire target text, where the target text is program code text to be supplemented or natural language text for describing a code function; and
a generation module 702, configured to input the target text into a code generation model to obtain a target program code generated based on the target text, where the code generation model is obtained by training with a code understanding task and a code generation task, and the code understanding task is used for the code generation model to learn a syntax feature and a semantic feature of a sample program code, and the code generation task is used for the code generation model to learn a process of generating a new program code based on the sample program code.

Optionally, the code generation model includes a code understanding layer, a code generation layer, and a shared representation layer, the result output by the shared representation layer is used for being input into the code understanding layer or the code generation layer, and the apparatus 700 further includes a training module, configured to:
when the code understanding task is executed, perform masking processing on the sample program code to obtain a mask sequence, input the mask sequence into the code generation model to obtain a first prediction code by the shared representation layer and the code understanding layer, and adjust parameters of the code understanding layer and the shared representation layer based on the first prediction code; and
when the code generation task is executed, input the sample program code into the code generation model to obtain a second prediction code by the shared representation layer and the code generation layer, and adjust parameters of the code generation layer and the shared representation layer based on a result output by the code generation model.

Optionally, the training module is configured to:
perform tokenization on the sample program code to obtain a token sequence;
randomly select a first preset proportion of first target tokens in the token sequence, and replace the first target tokens with a first preset mask symbol to obtain the mask sequence; and/or
randomly select a second preset proportion of second target tokens in the token sequence, and randomly select one target remaining token from remaining tokens for each second target token, and replace the second target token with the target remaining token to obtain the mask sequence, where the remaining tokens are tokens in the token sequence except the second target tokens.

Optionally, the training module is configured to:
perform tokenization on the sample program code to obtain a token sequence;
determine a function token for characterizing a function name in the token sequence, select a third preset proportion of target function tokens in the function tokens randomly, and replace the target function tokens with a second preset mask symbol to obtain the mask sequence; and/or
determine an interface token for characterizing an interface name in the token sequence, select a fourth preset proportion of target interface tokens in the interface tokens randomly, and replace the target interface tokens with a third preset mask symbol to obtain the mask sequence.

Optionally, the training module is configured to:
determine a feature vector sequence corresponding to the mask sequence;
for each feature vector in the feature vector sequence, obtain an intermediate feature vector by the shared representation layer performing calculation according to all feature vectors located before and after the feature vector in the feature vector sequence and an attention mechanism;
for each intermediate feature vector, obtain a target feature vector by the code understanding layer performing attention calculation according to intermediate feature vectors except the intermediate feature vector and the attention mechanism; and
obtain a first prediction program code according to the target feature vector.

Optionally, the training module is configured to:
determine a feature vector sequence corresponding to the sample program code, where the feature vector sequence includes N feature vectors, and N is a positive integer;
for an i-th feature vector in the feature vector sequence, perform, by the shared representation layer, calculation according to all feature vectors located before and after the i-th feature vector in the feature vector sequence and an attention mechanism to obtain an i-th intermediate feature vector, where i is a positive integer;
for the i-th intermediate feature vector, perform, by the code generation layer, calculation according to preceding feature vectors and the attention mechanism to obtain a target feature vector, where the preceding feature vectors are all intermediate feature vectors obtained before the i-th intermediate feature vector; and
obtain a second prediction program code according to the target feature vector.

Optionally, the apparatus 700 further includes a preprocessing module, configured to:
acquire a code dataset, where the code dataset includes a plurality of code files;
perform at least one of the following preprocessing steps for each code file to obtain a target code dataset: when the proportion of the number of characters to the total number of symbols in a code file is less than a preset character proportion, deleting the code file from the code dataset; when the average number of characters per line of code in a code file is greater than a first preset threshold, deleting the code file from the code dataset; and when the number of characters of comment information in a code file is greater than a second preset threshold, deleting the code file from the code dataset; and
determine the program code corresponding to each code file in the target code dataset as the sample program code.

Optionally, the code generation model is used to obtain the target program code generated based on the target text by:
determining a prediction token based on the target text, and using the prediction token as an initial target token to cyclically perform the following process:
concatenating the target token into a token sequence corresponding to the target text to obtain a target token sequence, determining a plurality of candidate prediction tokens and a probability of each candidate prediction token in a preset vocabulary based on the target token sequence, and randomly selecting one token from a candidate set corresponding to the candidate prediction tokens as a new target token, until the length of the target token sequence reaches a preset length or the target token is a preset end symbol;
where the sum of the probabilities of the candidate prediction tokens in the candidate set is greater than a preset probability.

Regarding the apparatus in the above embodiments, the specific manners of operations performed by the modules thereof have been described in detail in the method embodiments, and will not be described in detail here.

Based on the same concept, the present disclosure further provides a non-transitory computer readable medium, on which a computer program is stored, where the program, when executed by a processing apparatus, implements the steps of any of the above code generation methods.

Based on the same concept, the present disclosure further provides an electronic device, including:
a storage apparatus, on which a computer program is stored; and
a processing apparatus, configured to execute the computer program in the storage apparatus to implement the steps of any of the above code generation methods.

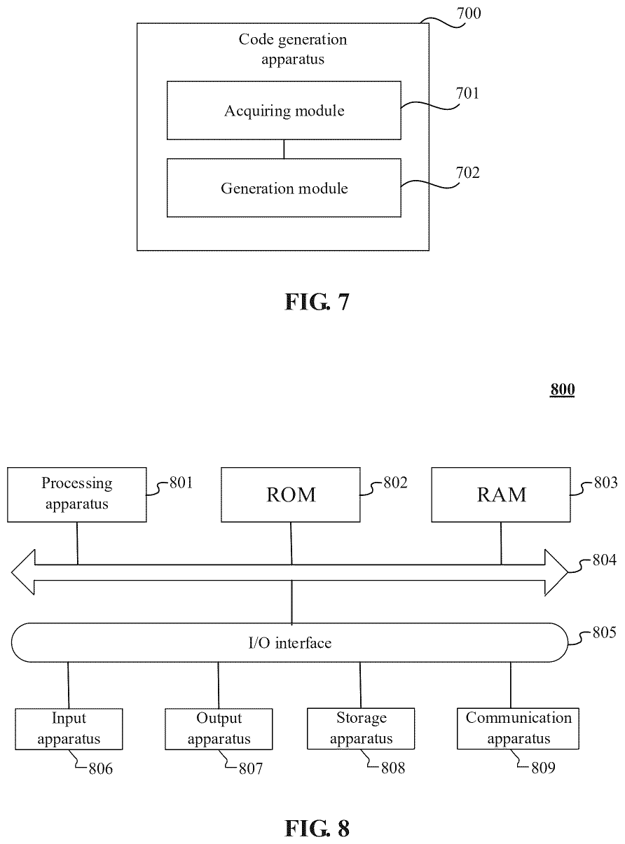

Reference is made to FIG. 8 below, which illustrates a schematic structural diagram of an electronic device 800 suitable for implementing the embodiments of the present disclosure. The terminal device in the embodiments of the present disclosure may include, but is not limited to, a mobile terminal such as a mobile phone, a notebook computer, a digital broadcast receiver, a PDA (Personal Digital Assistant), a PAD (tablet computer), a PMP (Portable Multimedia Player), a vehicle-mounted terminal (such as a vehicle navigation terminal), and a fixed terminal such as a digital TV, a desktop computer, etc. The electronic device shown in FIG. 8 is only an example, and should not bring any limitation to the function and use scope of the embodiments of the present disclosure.

As shown in FIG. 8, the electronic device 800 may include a processing apparatus (such as a central processing unit and a graphics processor) 801. The processing apparatus 801 may perform various appropriate actions and processes according to a program stored in a read-only memory (ROM) 802 or a program loaded from a storage apparatus 808 into a random access memory (RAM) 803. The RAM 803 further stores various programs and data necessary for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touch pad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 may allow the electronic device 800 to perform wireless or wired communication with other devices to exchange data. Although FIG. 8 shows the electronic device 800 having various apparatuses, it should be understood that not all of the illustrated apparatuses are necessarily implemented or included. More or fewer apparatuses may be implemented or included alternatively.

In particular, according to the embodiments of the present disclosure, the processes described above with reference to the flowcharts may be implemented as computer software programs. For example, the embodiments of the present disclosure include a computer program product, which includes a computer program carried on a non-transitory computer-readable medium, and the computer program includes program codes for executing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the above functions defined in the method of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program that can be used by or in conjunction with an instruction execution system, apparatus, or device. In the present disclosure, the computer-readable signal medium may include a data signal propagated in a baseband or as a part of a carrier wave, and computer-readable program codes are carried in the data signal. This propagated data signal can take many forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in conjunction with an instruction execution system, apparatus, or device. The program codes contained in the computer-readable medium may be transmitted by any suitable medium, including but not limited to an electric wire, an optical cable, an RF (radio frequency), etc., or any suitable combination thereof.

In some implementations, communication may be performed by using any currently known or future developed network protocol such as HTTP (Hypertext transfer protocol), and may be interconnected with digital data communication (for example, a communication network) in any form or medium. Examples of the communication network include a local area network (“LAN”), a wide area network (“WAN”), an internet (for example, the Internet), and a peer-to-peer network (for example, an ad hoc peer-to-peer network), as well as any currently known or future developed network.

The above computer-readable medium may be included in the above electronic device, or may exist alone without being assembled into the electronic device.

The above computer-readable medium carries one or more programs, and when the above one or more programs are executed by the electronic device, the electronic device is caused to: acquire target text, wherein the target text includes program code text to be supplemented or natural language text for describing a code function; and input the target text into a code generation model to obtain a target program code generated based on the target text, where the code generation model is obtained by training a code understanding task and a code generation task, the code understanding task is used for the code generation model to learn a syntax feature and a semantic feature of a sample program code, and the code generation task is used for the code generation model to learn a process of generating a new program code based on the sample program code.

The computer program codes for performing the operations of the present disclosure may be written in one or more programming languages or a combination thereof. The above programming languages include but are not limited to object-oriented programming languages such as Java, Smalltalk, C++, and also include conventional procedural programming languages such as “C” language or similar programming languages. The program code may be executed entirely on the user's computer, partly on the user's computer, as a stand-alone software package, partly on the user's computer and partly on a remote computer, or entirely on the remote computer or server. In the case of the remote computer, the remote computer may be connected to the user's computer through any kind of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession can, in fact, be executed substantially concurrently, or the blocks can sometimes be executed in the reverse order, depending upon the functionality involved. It should also be noted that, each block of the block diagrams and/or flowcharts, and combinations of blocks in the block diagrams and/or flowcharts, can be implemented by a special-purpose hardware-based system that performs the specified functions or operations, or can also be implemented by a combination of special-purpose hardware and computer instructions.

The modules involved in the embodiments of the present disclosure may be implemented in software or hardware. The name of the module does not constitute a limitation of the module itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in conjunction with an instruction execution system, apparatus or device. The machine-readable medium may be a machine-readable signal medium or a machine-readable storage medium. The machine-readable medium may include, but is not limited to, an electrical, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept, for example, a technical solution formed by replacing the above features with technical features having similar functions disclosed in the present disclosure (but not limited to).

In addition, although operations are depicted in a particular order, this should not be understood as requiring that such operations be performed in the particular order shown or in a sequential order. Under certain circumstances, multitasking and parallel processing may be advantageous. Likewise, although the above discussion contains several specific implementation details, these should not be interpreted as limiting the scope of the present disclosure. Certain features that are described in the context of separate embodiments may also be implemented in combination in a single embodiment. On the contrary, various features described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only example forms of implementing the claims. Regarding the apparatus in the above embodiments, the specific manners of operations performed by the modules thereof have been described in detail in the method embodiments, and will not be described in detail here.

1. A code generation method, comprising:
acquiring target text, wherein the target text comprises program code text to be supplemented or natural language text for describing a code function; and
inputting the target text into a code generation model to obtain a target program code generated based on the target text, wherein the code generation model is obtained by training with a code understanding task and a code generation task, and the code understanding task is used for the code generation model to learn a syntax feature and a semantic feature of a sample program code, and the code generation task is used for the code generation model to learn a process of generating a new program code based on the sample program code.

2. The method of claim 1, wherein the code generation model comprises a code understanding layer, a code generation layer and a shared representation layer, a result output by the shared representation layer is used for being input into the code understanding layer or the code generation layer, and a training step of the code generation model comprises:
in response to the code understanding task being executed, performing masking processing on the sample program code to obtain a mask sequence, and inputting the mask sequence into the code generation model to obtain a first prediction code by the shared representation layer and the code understanding layer, and adjusting parameters of the code understanding layer and parameters of the shared representation layer based on the first prediction code; and
in response to the code generation task being executed, inputting the sample program code into the code generation model to obtain a second prediction code by the shared representation layer and the code generation layer, and adjusting parameters of the code generation layer and parameters of the shared representation layer based on a result output by the code generation model.

3. The method of claim 2, wherein performing the masking processing on the sample program code to obtain the mask sequence comprises:
performing tokenization on the sample program code to obtain a token sequence;
selecting a first preset proportion of first target tokens in the token sequence randomly, and replacing the first target tokens with a first preset mask symbol to obtain the mask sequence; and/or
selecting a second preset proportion of second target tokens in the token sequence randomly, and selecting, for each second target token, a target remaining token from remaining tokens randomly, and replacing the second target token with the target remaining token to obtain the mask sequence, wherein the remaining tokens are tokens in the token sequence except the second target tokens.

4. The method of claim 2, wherein performing the masking processing on the sample program code to obtain the mask sequence comprises:
performing tokenization on the sample program code to obtain a token sequence;
determining a function token for characterizing a function name in the token sequence, randomly selecting target function tokens in the function tokens by a third preset proportion, and replacing the target function tokens with a second preset mask symbol to obtain the mask sequence; and/or
determining an interface token for characterizing an interface name in the token sequence, randomly selecting a fourth preset proportion of target interface tokens in the interface tokens, and replacing the target interface tokens with a third preset mask symbol to obtain the mask sequence.

5. The method of claim 2, wherein inputting the mask sequence into the code generation model to obtain the first prediction code by the shared representation layer and the code understanding layer comprises:
determining a feature vector sequence corresponding to the mask sequence;
for each feature vector in the feature vector sequence, obtaining an intermediate feature vector by the shared representation layer performing calculation according to all feature vectors located before and after the feature vector in the feature vector sequence and an attention mechanism;
for each intermediate feature vector, obtaining a target feature vector by the code understanding layer performing attention calculation according to intermediate feature vectors excluding the intermediate feature vector and the attention mechanism; and
obtaining a first prediction program code according to the target feature vector.

6. The method of claim 2, wherein inputting the sample program code into the code generation model to obtain the second prediction code by the shared representation layer and the code generation layer comprises:
determining a feature vector sequence corresponding to the sample program code, wherein the feature vector sequence comprises a number N of feature vectors, and N is a positive integer;
for an ith feature vector in the feature vector sequence, obtaining an i-th intermediate feature vector by the shared representation layer performing calculation according to all feature vectors located before and after the i-th feature vector in the feature vector sequence and an attention mechanism, wherein i is a positive integer;
for the i-th intermediate feature vector, obtaining a target feature vector by the code generation layer performing according to preceding feature vectors and the attention mechanism, wherein the preceding feature vectors are all intermediate feature vectors obtained before the i-th intermediate feature vector; and
obtaining a second prediction program code according to the target feature vector.

7. The method of claim 1, wherein the sample program code is obtained by:
acquiring a code dataset comprising a plurality of code files;
performing, for each of the code files, at least one of the following preprocessing steps to obtain a training dataset: in response to a proportion of a number of characters to a total number of symbols in a code file being greater than or equal to a preset character proportion, adding the code file to the training dataset; in response to an average number of characters per line of code in a code file being less than or equal to a first preset threshold, adding the code file to the training dataset; or in response to a number of characters of comment information in a code file being less than or equal to a second preset threshold, adding the code file to the training dataset; and
determining a program code corresponding to each of the code files in the training dataset as the sample program code.

8. The method of claim 1, wherein the code generation model is used for obtaining the target program code generated based on the target text by:
determining a prediction word based on the target text, and using the prediction word as an initial target word to cyclically perform the following process:
concatenating the target token to a token sequence corresponding to the target text to obtain a target token sequence, and determining a plurality of candidate prediction words and a probability of each of the candidate prediction words in a preset vocabulary based on the target token sequence, and selecting a word from a candidate set corresponding to the candidate prediction words as a new target word randomly until a length of the target token sequence reaches a preset length or the target word is a preset end symbol;
wherein a sum of probabilities of the candidate prediction words in the candidate set is greater than a preset probability.

9. (canceled)

10. A non-transitory computer readable medium, storing a computer program thereon, wherein the program, when executed by a processing apparatus, cause the processing apparatus to:
acquire target text, wherein the target text comprises program code text to be supplemented or natural language text for describing a code function; and
input the target text into a code generation model to obtain a target program code generated based on the target text, wherein the code generation model is obtained by training with a code understanding task and a code generation task, and the code understanding task is used for the code generation model to learn a syntax feature and a semantic feature of a sample program code, and the code generation task is used for the code generation model to learn a process of generating a new program code based on the sample program code.

11. An electronic device, comprising:
a storage apparatus, storing a computer program thereon; and
a processing apparatus, configured to execute the computer program in the storage apparatus to:
acquire target text, wherein the target text comprises program code text to be supplemented or natural language text for describing a code function; and
input the target text into a code generation model to obtain a target program code generated based on the target text, wherein the code generation model is obtained by training with a code understanding task and a code generation task, and the code understanding task is used for the code generation model to learn a syntax feature and a semantic feature of a sample program code, and the code generation task is used for the code generation model to learn a process of generating a new program code based on the sample program code.

12. The non-transitory computer readable medium of claim 10, wherein the code generation model comprises a code understanding layer, a code generation layer and a shared representation layer, a result output by the shared representation layer is used for being input into the code understanding layer or the code generation layer, and in a training step of the code generation model, the processing apparatus is caused to:
in response to the code understanding task being executed, perform masking processing on the sample program code to obtain a mask sequence, and input the mask sequence into the code generation model to obtain a first prediction code by the shared representation layer and the code understanding layer, and adjust parameters of the code understanding layer and parameters of the shared representation layer based on the first prediction code; and
in response to the code generation task being executed, input the sample program code into the code generation model to obtain a second prediction code by the shared representation layer and the code generation layer, and adjust parameters of the code generation layer and parameters of the shared representation layer based on a result output by the code generation model.

13. The non-transitory computer readable medium of claim 12, wherein the program that causes the processing apparatus to perform the masking processing on the sample program code to obtain the mask sequence further causes the processing apparatus to:
perform tokenization on the sample program code to obtain a token sequence;
select a first preset proportion of first target tokens in the token sequence randomly, and replace the first target tokens with a first preset mask symbol to obtain the mask sequence; and/or
select a second preset proportion of second target tokens in the token sequence randomly, and select, for each second target token, a target remaining token from remaining tokens randomly, and replace the second target token with the target remaining token to obtain the mask sequence, wherein the remaining tokens are tokens in the token sequence except the second target tokens.

14. The non-transitory computer readable medium of claim 12, wherein the program that causes the processing apparatus to perform the masking processing on the sample program code to obtain the mask sequence further causes the processing apparatus to:
perform tokenization on the sample program code to obtain a token sequence;
determine a function token for characterizing a function name in the token sequence, randomly select target function tokens in the function tokens by a third preset proportion, and replace the target function tokens with a second preset mask symbol to obtain the mask sequence; and/or
determine an interface token for characterizing an interface name in the token sequence, randomly select a fourth preset proportion of target interface tokens in the interface tokens, and replace the target interface tokens with a third preset mask symbol to obtain the mask sequence.

15. The non-transitory computer readable medium of claim 12, wherein the program that causes the processing apparatus to input the mask sequence into the code generation model to obtain the first prediction code by the shared representation layer and the code understanding layer comprises:
determine a feature vector sequence corresponding to the mask sequence;
for each feature vector in the feature vector sequence, obtain an intermediate feature vector by the shared representation layer performing calculation according to all feature vectors located before and after the feature vector in the feature vector sequence and an attention mechanism;
for each intermediate feature vector, obtain a target feature vector by the code understanding layer performing attention calculation according to intermediate feature vectors excluding the intermediate feature vector and the attention mechanism; and
obtain a first prediction program code according to the target feature vector.

16. The non-transitory computer readable medium of claim 12, wherein the program that causes the processing apparatus to input the sample program code into the code generation model to obtain the second prediction code by the shared representation layer and the code generation layer further causes the processing apparatus to:
determine a feature vector sequence corresponding to the sample program code, wherein the feature vector sequence comprises a number N of feature vectors, and N is a positive integer;
for an ith feature vector in the feature vector sequence, obtain an i-th intermediate feature vector by the shared representation layer performing calculation according to all feature vectors located before and after the i-th feature vector in the feature vector sequence and an attention mechanism, wherein i is a positive integer;
for the i-th intermediate feature vector, obtain a target feature vector by the code generation layer performing according to preceding feature vectors and the attention mechanism, wherein the preceding feature vectors are all intermediate feature vectors obtained before the i-th intermediate feature vector; and
obtain a second prediction program code according to the target feature vector.

17. The non-transitory computer readable medium of claim 10, wherein the sample program code is obtained by the processing apparatus being caused to:
acquire a code dataset comprising a plurality of code files;
perform, for each of the code files, at least one of the following preprocessing steps to obtain a training dataset: in response to a proportion of a number of characters to a total number of symbols in a code file being greater than or equal to a preset character proportion, add the code file to the training dataset; in response to an average number of characters per line of code in a code file being less than or equal to a first preset threshold, adding the code file to the training dataset; or in response to a number of characters of comment information in a code file being less than or equal to a second preset threshold, add the code file to the training dataset; and
determine a program code corresponding to each of the code files in the training dataset as the sample program code.

18. The non-transitory computer readable medium of claim 10, wherein the code generation model is used for obtaining the target program code generated based on the target text by:
determining a prediction word based on the target text, and using the prediction word as an initial target word to cyclically perform the following process:
concatenating the target token to a token sequence corresponding to the target text to obtain a target token sequence, and determining a plurality of candidate prediction words and a probability of each of the candidate prediction words in a preset vocabulary based on the target token sequence, and selecting a word from a candidate set corresponding to the candidate prediction words as a new target word randomly until a length of the target token sequence reaches a preset length or the target word is a preset end symbol;
wherein a sum of probabilities of the candidate prediction words in the candidate set is greater than a preset probability.

19. The electronic device of claim 11, wherein the code generation model comprises a code understanding layer, a code generation layer and a shared representation layer, a result output by the shared representation layer is used for being input into the code understanding layer or the code generation layer, and in a training step of the code generation model, the processing apparatus is caused to:
in response to the code understanding task being executed, perform masking processing on the sample program code to obtain a mask sequence, and input the mask sequence into the code generation model to obtain a first prediction code by the shared representation layer and the code understanding layer, and adjust parameters of the code understanding layer and parameters of the shared representation layer based on the first prediction code; and
in response to the code generation task being executed, input the sample program code into the code generation model to obtain a second prediction code by the shared representation layer and the code generation layer, and adjust parameters of the code generation layer and parameters of the shared representation layer based on a result output by the code generation model.

20. The electronic device of claim 19, wherein the computer program that causes the processing apparatus to perform the masking processing on the sample program code to obtain the mask sequence further causes the computer processing apparatus to:
perform tokenization on the sample program code to obtain a token sequence;
select a first preset proportion of first target tokens in the token sequence randomly, and replace the first target tokens with a first preset mask symbol to obtain the mask sequence; and/or
select a second preset proportion of second target tokens in the token sequence randomly, and select, for each second target token, a target remaining token from remaining tokens randomly, and replace the second target token with the target remaining token to obtain the mask sequence, wherein the remaining tokens are tokens in the token sequence except the second target tokens.

21. The electronic device of claim 19, wherein the computer program that causes the processing apparatus to perform the masking processing on the sample program code to obtain the mask sequence further causes the computer processing apparatus to:
perform tokenization on the sample program code to obtain a token sequence;
determine a function token for characterizing a function name in the token sequence, randomly select target function tokens in the function tokens by a third preset proportion, and replace the target function tokens with a second preset mask symbol to obtain the mask sequence; and/or
determine an interface token for characterizing an interface name in the token sequence, randomly select a fourth preset proportion of target interface tokens in the interface tokens, and replace the target interface tokens with a third preset mask symbol to obtain the mask sequence.
